(19) United States
(12) Patent Application Publication
(10) Pub. No.: US 2016/0196494 A1
(43) Pub. Date: Jul. 7, 2016

(54) LOCATION ANALYSIS FOR ANALYTICS

(71) Applicant: VODAFONE IP LICENSING LIMITED, Newbury Berkshire (GB)

(72) Inventors: Kevin Scarr, London (GB); Richard Vilton, London (GB); Roy Davies, London (GB); Jonathan Smith, London (GB); Brendan Patrick Ludden, London (GB)

(21) Appl. No.: 14/977,333

(22) PCT Filed: Jun. 20, 2014
(86) PCT No.: PCT/GB2014/051901

§ 371 Date: Dec. 21, 2015

(30) Foreign Application Priority Data
Jun. 20, 2013 (GB) 1311037.4
Sep. 9, 2013 (GB) 1316022.1

(51) Int. Cl. G06N 5/04

(52) U.S. Cl. CPC G06N 5/04

(57) ABSTRACT

A method for inferring a relationship between a first user and an area is disclosed, where the user is associated with one or more user devices. The method comprises retrieving event records having user device information corresponding to the user devices, and inferring, based on the event records, a relationship between the user and the area. A method for determining the presence of users at a location of a plurality of locations organised in a hierarchical structure is also disclosed. The method comprises receiving an indication of a location selected from the hierarchical structure, determining nodes associated with the selected location, retrieving event records from each node, and determining, based on the retrieved records, a number of users located at the selected location.

### BACKGROUND

Every business or service operates within a spatial dimension—whether this is a physical location such as a retail outlet or a virtual location via a website. In order to effectively operate the business or service, it is essential to understand the demographics and psychographic behaviour of the customers and the users of the business or service. This process is known as “footfall analytics”.

Typically, footfall analytics are performed within the retail business sector and are concerned with measuring the number of visitors to a retail outlet and the demographics of those visitors, and ideally how these translate to sales.

Footfall analytics is not just limited to the retail environment however. For example, a hospital may wish to understand the movements of its patients, a local authority may wish to understand the impact of a planned event or an online retailer may wish to understand where their customers are when using the service.

One area where footfall analytics has a particularly important application is in the field of facility management. Modern facilities comprise a number of subsystems which are configured to control aspects of the facilities. This can include both indoor facilities (such as buildings) and outdoor facilities (such as streets).

Some subsystems are controlled based on the number or characteristics of the people that are present in a given location. This traditionally involves manually counting the number of people who enter a location and interviewing a sample to determine their characteristics, such as their reason for visiting the location. This manually gathered information can then be used to approximate the number and characteristics of people in the area in the future. Based on this approximation, the various parameters of the subsystem (such as output levels and set-points) can be set. However, a key weakness with this manual process is that it is a very time-consuming to initially gather the data. Further, because the data is not at all real-time, and in fact relies on a past sample being extrapolated for future occasions, it can be very inaccurate, causing poor performance of the subsystems.

Although accurate footfall analytics would provide the best basis for automated control of subsystems, the difficulty with gathering the data has led to attempts in the prior art to consider other approaches. Some subsystems can be automatically controlled by linking the subsystem to one or more sensors. The output of the subsystem could then be automatically adjusted based on the sensor reading. For example, an air conditioning subsystem may be configured to regulate the temperature within an area to remain within two set-points, based on periodic or continuous sensor readings. However, such an approach is only suitable where there is an easily measured output, and in any case requires monitoring infrastructure to be installed and maintained.

A particularly coarse method of automatic control involves using motion sensors or the like to determine the presence of one or more people. However, this does not provide any indication of the number or kind of people who are present, and is prone to a large number of false positives and true negatives. For example, it is very difficult (or even practically impossible) to determine whether a person is a repeat visitor. While it may be possible for such sensors to determine whether a person is an adult or a child (based on the size of the person), even this is typically very inaccurate and unreliable. Any further analysis is generally impossible. Such methods therefore are only appropriate in very limited situations where accuracy and precision is not so important.

Thus there is a need in the art for improvements in methods of analysing user footfall and of controlling associated subsystems based on user footfall, or to at least provide the public with a useful choice.

### SUMMARY OF INVENTION

In a first aspect, there is provided a method for inferring a relationship between a first user and an area. The first user is associated with one or more first user devices. One or more nodes (e.g., a telecommunication node) are capable of serving user devices located within the area. The method comprises retrieving a first subset of a plurality of event records. Each event record corresponds to an event in a node and comprises user device information, time information, and location information. The retrieved first subset comprises one or more event records having user device information corresponding to the one or more first user devices. Subsequently, a relationship between the first user and the area can be inferred, based on one or more of the user device information, time information and location information associated with the retrieved events.

In preferred embodiments, the method further comprises storing the relationship in a data store. In this manner, the stored relationship can be used to assist in

Inferring a relationship can comprise: filtering the first subset to produce a second subset, the second subset comprising event records of the first subset having time information relating to a time between a first time and a second time; determining an average and a standard deviation for each location having at least one corresponding event record in the second subset; and inferring the first location for the user based on the average and the standard deviation for each location.

In preferred embodiments, the first time is a day time and the second time is a night time. Thus inferring a relationship between the user and the location comprises recording that the location is a work location for the user. This reflects that many users will be located at work during the day.

In preferred embodiments, the first time is a night time and the second time is a day time. Thus inferring a relationship between the user and the location comprises recording that the location is a home location for the user. This reflects that many users will be located at home during the night.

Inferring a relationship may comprise, for each location corresponding to the location information in at least one record in the first subset: calculating the number of records having location information relating to the location; and inferring a relationship between the user and the location based on the number of records.

Inferring a relationship between the user and the first location based on the number may further comprise: if the number is greater than a first number, recording that the user is a site worker at the first location; if the number is less than a first number but greater than a second number, and if a work location for the user is the same as a home location for the user, recording that the user is a home worker at the first location; if the number is less than a first number but greater than a second number, and if a work location for the user is not the same as a home location for the user, and the first location is associated with the user, recording that the user is an internal visitor at the first location; and if the number is less than a first number but greater than a second number, and if a work location for the user is not the same as a home location for the user, and the first location is not associated with the user, recording that the user is an external visitor at the first location.

The event records may comprise charging data records generated at the node. In this manner, there is a reduced overhead in generating the event records, as charging data records will be generated in any case during ordinary operation of the node.

In preferred embodiments, the operation of a subsystem in a facility is automatically controlled based on the inferred relationship.

In a second aspect, there is provided a computer-readable medium having computer-executable instructions stored thereon which, when executed by a computer, cause the computer to perform the method of the first aspect.

In a third aspect, there is provided a method for determining the presence of users at a location of a plurality of locations organised in a hierarchical structure having a plurality of levels. The plurality of locations is part of an area, with each level of the hierarchical structure being associated with an area type of the area. A plurality of nodes are capable of serving user devices located within the area.

First, an indication of a first location selected from the hierarchical structure is received. A subset of the plurality of nodes associated with the selected first location is then determined. Each of the subset of nodes is capable of serving user devices located at the first location. From each node in the subset of the plurality of nodes, one or more event records is retrieved. Each event record corresponds to a user device event at the associated node and comprises user device information, event information and location information. Finally, based on the retrieved records, a number of users located at said selected first location is determined. In this manner, the presence of users in a hierarchical structure can be accurately and efficiently be obtained.

In preferred embodiments, the method further comprises storing the number of users in a data store.

In preferred embodiments, the method further comprises comparing the number of users at the first location to a predetermined user capacity for the first location. In this manner, action can be taken in the capacity of the first location is exceeded, by for example raising an alarm condition.

The area type may comprise one of a zone, a floor or a building. These reflect typical situations where an area may have a hierarchical structure.

Determining a subset of the plurality of nodes associated with the selected first location may comprise forming the subset from the node associated with the first location and descendants of the node.

In a fourth aspect, there is provided a computer-readable medium having computer-executable instructions stored thereon which, when executed by a computer, cause the computer to perform the method of the third aspect.

### BRIEF DESCRIPTION

The present invention will now be described with reference to the accompanying drawings, in which:

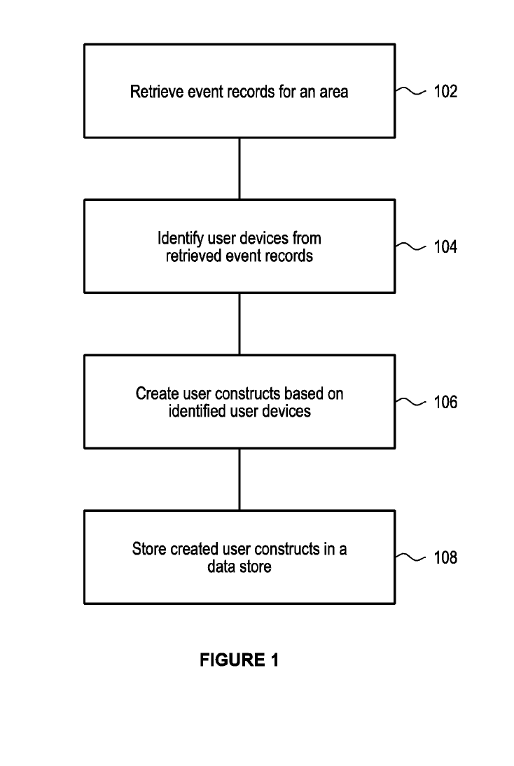

FIG. 1 shows a method for processing the event records for use in footfall analytics;

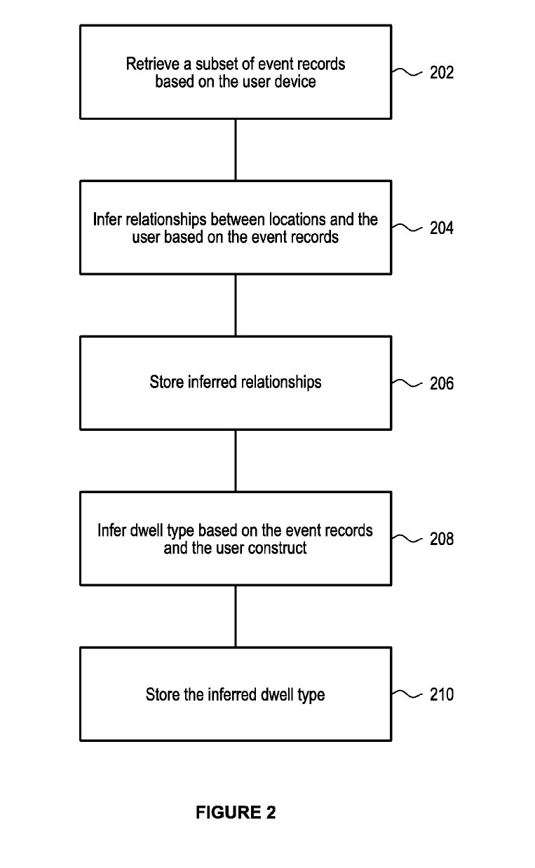

FIG. 2 shows a method for determining which locations bear certain relationships to a user;

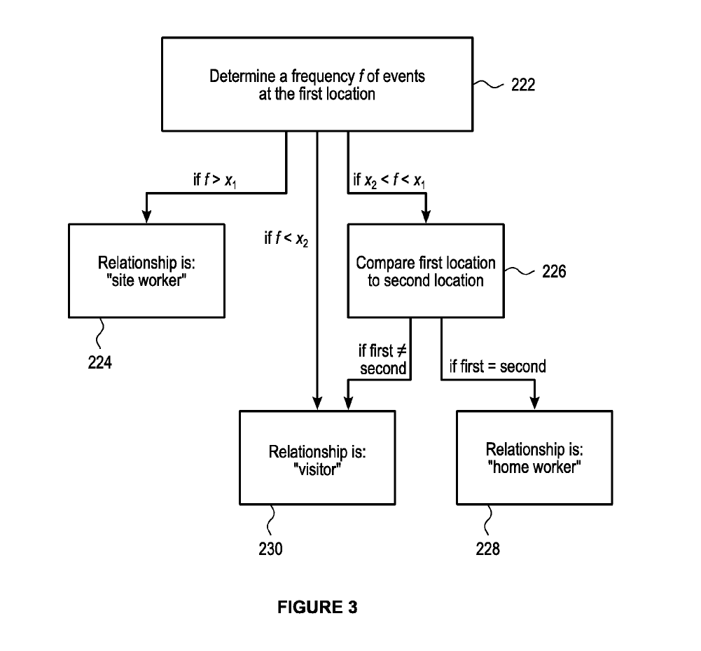

FIG. 3 shows a method for inferring a dwell type of a user for a location;

Figure shows an exemplary structure based on a hierarchy of cells;

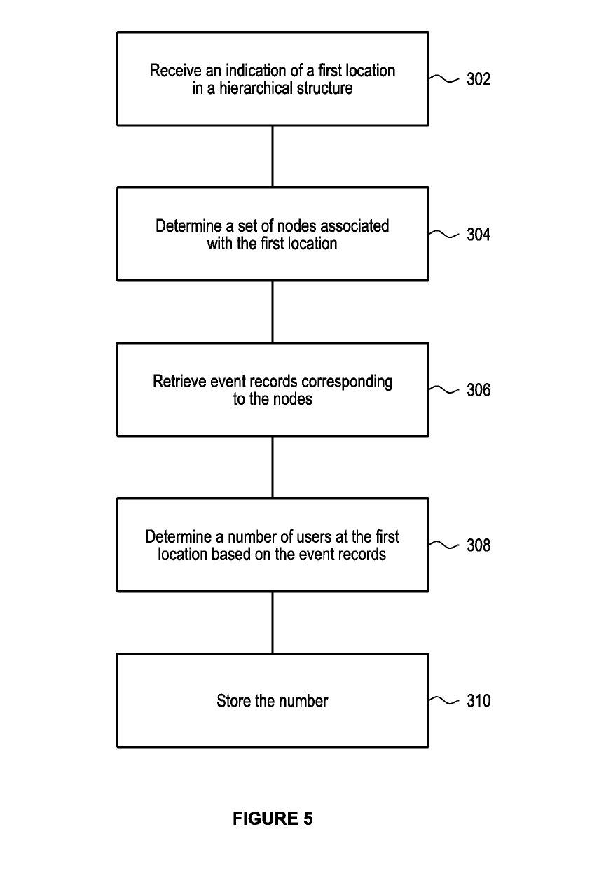

FIG. 5 shows a first method for analysing event records that occur in locations forming a hierarchical structure;

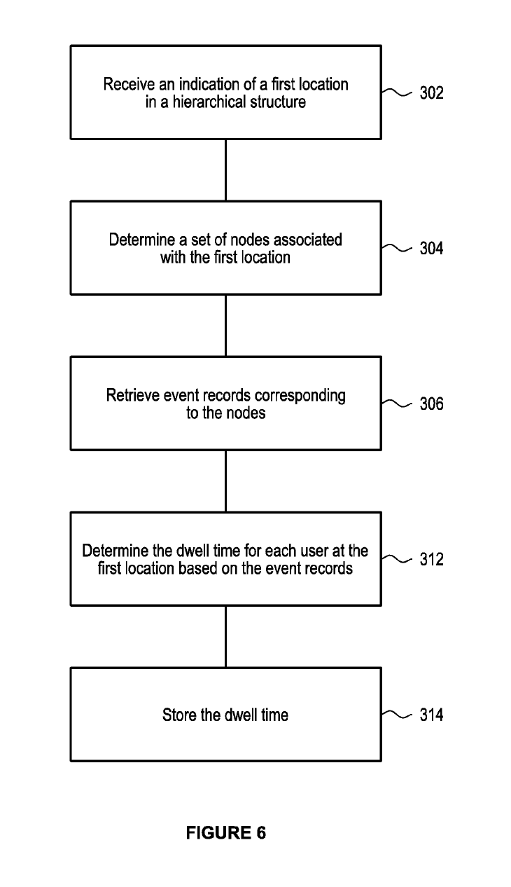

FIG. 6 shows a second method for analysing event records that occur in locations forming a hierarchical structure;

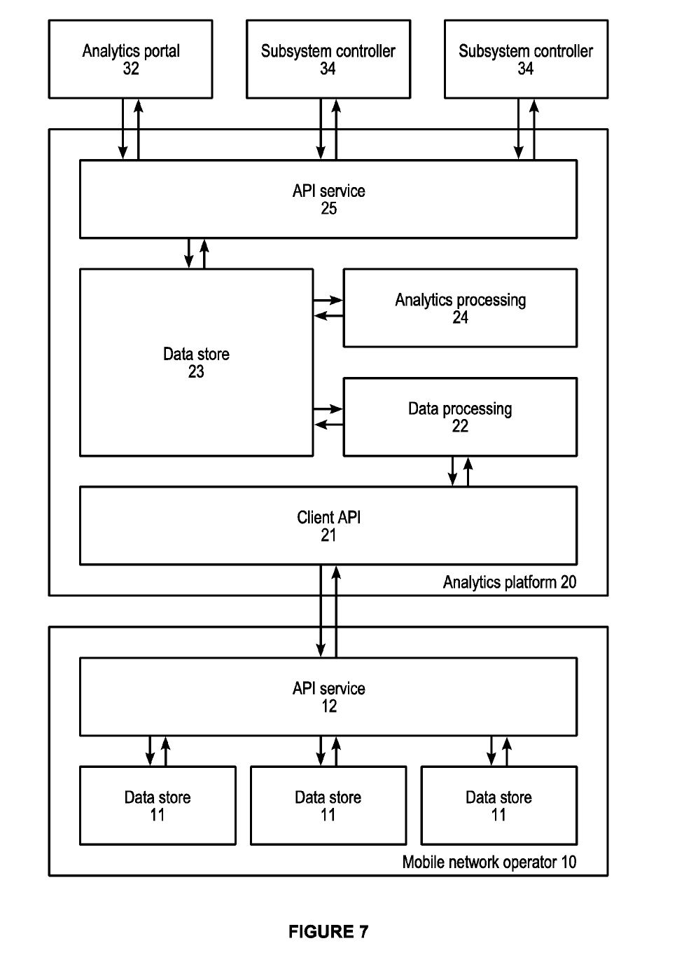

FIG. 7 shows an exemplary system for implementing the described methods; and

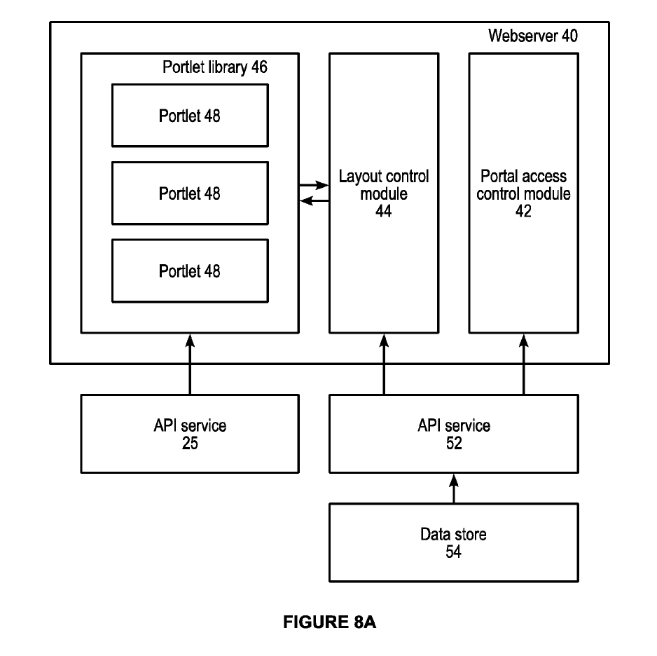

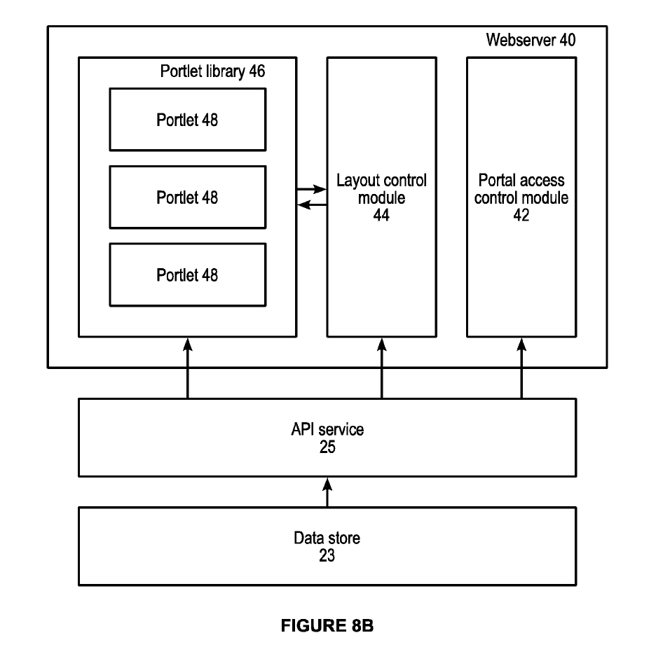

FIGS. 8A and 8B show exemplary embodiments for an analytics portal.

### DETAILED DESCRIPTION

In order to achieve any useful footfall analytics, the relevant data must first be gathered. In practice, the vast majority of people carry one or more devices with them which communicate with a base station (or telecommunications node) for mobile services and the like. Typically, a device communicates with the nearest base station.

Based on this, if a device is connected to a base station, it can be reasoned that the device is located within the area around the base station which is closer to the base station than to any other base station. This analysis can be modelled mathematically using a Voronoi algorithm to divide a large geographical area with a plurality of base stations into cells. Of course, other methodologies can be used to map mobile telecommunication cells and/or communication coverage areas into geographical areas. Each cell can therefore be mapped to a geographical area which will typically be centred on the base station.

The base station can be a conventional mobile telephony base station, providing services to a macrocell which covers an area several kilometres across. In some settings, smaller cells (such as femtocells) may also be used, particularly where service is required indoors. In such cases, each floor or room of a building may be a separate cell, and user devices can communicate with the base station for their floor.

In use, the user device communicates with the base station. In doing so, the base station typically generates and stores event records based on the events that have occurred. These events can, for example, include a phone call being established or a text message being sent. Each event record comprises time data indicating when the event occurred, device data indicating the user device that was involved, type data indicating the type of event that occurred, and cell data indicating the network cell in which the event occurred.

The time data can include a date and a time at which the event started, and the duration of the event. Alternatively, it can include a first date and time at which the event started, and a second date time at which the event finished.

The device data uniquely identifies the device which was involved in the event. This is typically by means of one or more IDs which map to a device, a user account or a user. Commonly, this includes one or more of an MSISDN for the device, an IMSI for a user (or a SIM card or device associated with the user), or an IMEI for the device. In some cases, anonymised IDs (particularly an anonymised MSISDN) may be used.

The type data identifies the type of event that occurred. For example, the event type data may indicate that the event was a telephone call. This may be done by means of a code which corresponds to an entry in a look-up table.

The cell data can be simply an identifier for the cell. However, using the mapping between cells and geographical areas, the cell data can also be used as a geographical identifier. Accordingly, using this mapping, location data for the event record can be easily computed which identifies a geographical area or location at which the event occurred.

In many cases, the event records are generated during the ordinary operation of the base station. In this case, there is little additional overhead to generate the event records, as the event records will be generated regardless of whether they are to be used for footfall analytics. In some cases, the event records may include charging data records (CDRs) generated for charging a user's account.

Although the event records above have been described with reference to events occurring at a base station, event records may additionally or alternatively be generated and/or retrieved from outside of the operation of a base station. In particular, event records may comprise records of events occurring in other networks. For example, the event records may relate to a non-telecommunication network (such as requests and responses passing through a WiFi network), the use of GPS, the internal state of devices (such as a device being switched on or connecting to a different cell) or the like.

### Data Gathering

Turning now to FIG. 1, a method for processing the event records for a geographical area is shown. Facility management subsystems are typically configured to provide services to different areas separately. For example, lighting may be required in a first area, but not a second area, even though both areas are managed by a single subsystem. It can therefore be useful to consider event records for each geographical area separately.

At step 102, event records are retrieved for a given geographical area. To do so, the identifier for the cell corresponding to the geographical area is retrieved. This can be done using a look-up table or the like, which maps locations to cells. The stored event records are then filtered to produce a subset of event records relating to the identified cell. Thus, the subset only relates to events that occur within the given geographical area.

At step 104, a set of devices is identified, each of which has at least one corresponding event record in the subset of event records. The event records can then be split into multiple further subsets, each of which relate to a single user device.

At step 106, a user construct is generated for the subset relating to each user device. Each user construct comprises the subset of the event records which relate to a device, and which in turn relate to a nominal user. In some cases, a user construct can actually relate to multiple devices, for example if a single user carries two devices with them.

The user constructs can be created without necessarily having any knowledge of the users directly. In this manner, the user constructs may be anonymous. Moreover, because each user construct may only relate to a single area, the same actual user may be seen as a first user construct in a first area, and a separate second user construct in a second area.

At step 108, these user constructs are stored in a data store for future use. Once the user constructs are generated and stored, footfall analysis can be performed.

### Inferring a Relationship Between a User and a Location

Most users have at least a number of locations which they frequent due to their relationship to the location. Although the actual locations will vary from user to user, each of these relationships tend to exhibit the same usage patterns. For example, a user may tend to visit a first location during weekdays, and may tend to visit a second location during evenings and nights.

It should be noted that the locations themselves need not have the same relationship for different users. The locations can therefore only be defined as having a particular relationship to a given user.

Each relationship will typically be modelled as one or more usage patterns which hold for the majority of users. This may be realised as an equation or stored procedure which can be used on a data set in determining which location bears that relationship to the user.

FIG. 2 shows a method for determining which locations bear certain relationships to a user. As noted above, each user is modelled as an anonymous user construct which has one or more associated user devices.

At step 202, a subset of the event records is retrieved. Each of the event records in the subset has device information corresponding to one or more of the user devices.

At step 204, relationships between one or more of the locations and the user are inferred based on the subset of the event records.

As an example of a first relationship (such as a work relationship), the location which has the most events occurring during the day should be selected as bearing a first relationship to the user. This is calculated by first analysing the number of events that occur during the day (such as from 08:00 to 18:00) at each location to produce an average and a standard deviation for the location. Once these have been calculated for each location, the location with the highest average and the lowest standard deviation is selected as bearing a first relationship to the user.

As an example of a second relationship (such as a home relationship), the location which has the most events occurring during the night should be selected as bearing a second relationship to the user. This is calculated by first analysing the number of events that occur during the night (such as from 20:00 to 06:00) at each location to produce an average and a standard deviation for the location. Once these have been calculated for each location, the location with the highest average and the lowest standard deviation is selected as bearing a second relationship to the user.

At step 206, the inferred relationships are recorded as being associated with the user construct (and thus the user), preferably by storing the relationship in a data store.

Once the location corresponding to each relationship is inferred, it may be possible to further categorise the user's relationship with the location by matching the inferred relationship to one or more further profiles. One example of this would be dwell types: for example, if the inferred location is associated with a work relationship, then a user may be further categorised as an internal visitor, an external visitor or a site worker.

Thus at step 208, for one or more of the relationships, a dwell type can be inferred based on the subset of event records and the user construct. A preferred embodiment of a method for inferring the dwell type is shown in FIG. 3.

At step 210, the dwell type is recorded as being associated with the user construct (and thus the user), preferably by storing in a data store.

FIG. 3 shows a preferred embodiment of step 208. This step is performed when a first location is determined to bear a first relationship to a user.

At step 222, the frequency of events at the location is determined for a given time period (usually at least a few days). This can be done by counting the number of event records in the subset which have location data corresponding to the location and time data corresponding to a time falling within the given time period. Alternatively, the total duration of events at the location during the given time period can be determined and used as the frequency.

If the frequency is greater than a first threshold (x₁), the method proceeds to step 224. At step 224, the dwell type is recorded as “site worker”, that is, the user is inferred to be a worker at the first location.

If the frequency is less than the first threshold (x₁), but greater than a lower second threshold (x₂), the method proceeds to step 226. At step 226, the first location is compared to a second location bearing a second relationship to the user.

If the first location and the second location are the same, the method proceeds to step 228. At step 228, the dwell type is recorded as “home worker”, that is, the user is inferred to be a work at the second location.

If the first location is different from the second location, or if the frequency is less than the second threshold, the method proceeds to step 230.

At step 230, the user is recorded as a “visitor” to the first location, that is, the user is inferred to be temporarily visiting the location. In some cases, this can be further categorised. If the user is associated with the first location in another way, such as by other data held in the user construct, the user can be recorded as an “internal visitor”. Otherwise, the user can be recorded as an “external visitor”.

In use, the relationships can be used in controlling one or more subsystems. An example of this may be in the provision of internet service. A user who is at one location may be taken to be more sensitive to delay in their internet service than a user at another location. Thus, when there is a need to prioritise service (such as when the demand for data transfer exceeds the availability), the internet subsystem may prioritise service to a user at one location over the service to a user at another location.

As a further example, the relationships may be used for contextualising dynamic content which is provided to a location. If a given location bears the same relationship to a large number of users, dynamic content provided to users in that location may be selected as being relevant to that relationship.

### Footfall Analytics in a Hierarchically Structured Location

In some cases, a naturally occurring area can actually comprise multiple areas, each of which includes a separate cell defined by base stations serving user devices. Most notably, this can occur in urban areas, where for example, a floor is a part of a building, and a building is part of a campus.

Event records typically only map to a single area, which is usually the most specific one available. For example, event records may refer to a cell corresponding to a floor, but not to the building. Thus, when approached naively, an analysis looking only at the building level may provide an inaccurate result.

These areas can be modelled as a hierarchical (or tree-like) structure, where each level of the structure corresponds to a different area type. In this manner, both the area itself and the computer model of the area may be said to be hierarchical.

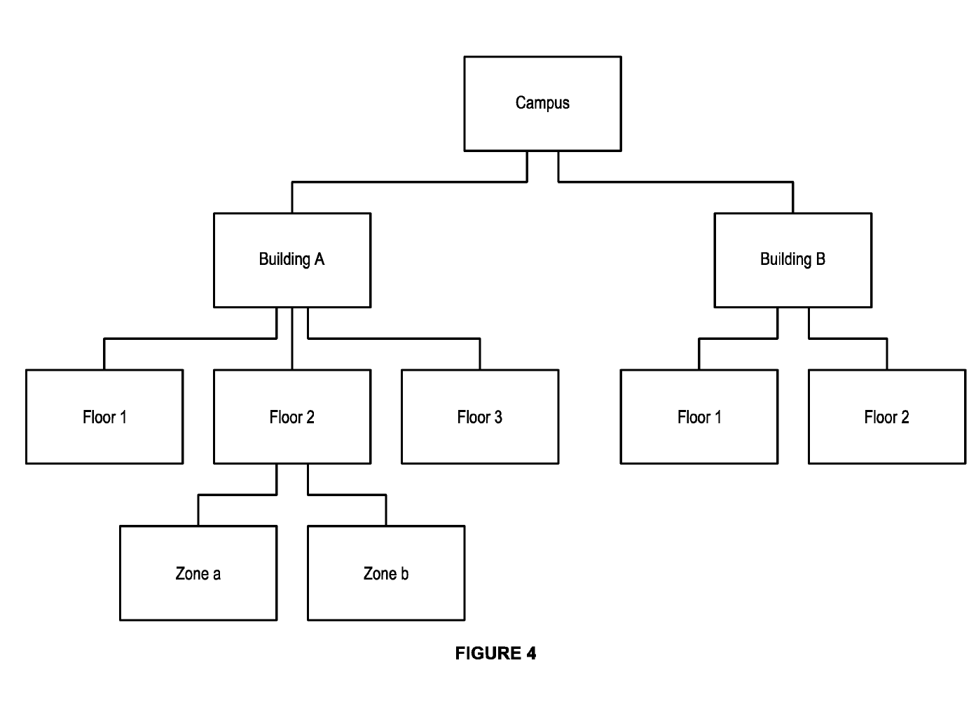

An example of such a structure is shown in FIG. 4. There, each node corresponds to a different area, where the parent of each node corresponds to an area which includes the child node. In this particular example, the campus is treated as a root node, which consists of two buildings, Building A and Building B. Building A has three floors, one of which itself has two zones. Building B has two floors.

Typically, the leaves of the hierarchical structure are defined by the placement of base stations, such that each leaf in the hierarchical structure corresponds to a cell, each cell having one or more base stations for serving user devices. The non-leaf nodes may also correspond to a cell which is not covered by one of the leaf nodes. For example, a building may have a base station which corresponds to a building-wide cell, while only a subset of the floors have floor-specific cells. Thus in some cases, the union of the areas of the child nodes do not necessarily match the area of the parent node.

When such a hierarchical structure is present, any analysis of the event records for the area can be adapted to take into consideration the hierarchical nature of the area. FIG. 5 shows a method for doing so.

At step 302, an indication of a first location is received. The first location is associated with a first node in the hierarchical structure. The first node will typically have one or more child nodes in the hierarchical structure.

At step 304, a subset of the plurality of nodes associated with the selected first location is determined. In particular, this subset comprises the first node together with any descendant nodes of the first node. As will be appreciated, this can be achieved through any suitable tree traversal algorithms that are known in the art.

At step 306, one or more event records associated with each of the subset of nodes is retrieved. In this case, an event record is associated with a node if the event record includes an identifier for the user device and an identifier for the location corresponding to the node, or in other words, if the event involved the user device and occurred at the location.

The event records may be filtered to avoid the risk of double counting a user who is recorded as being both at a first location and at a child of that first location. For example, there may be event records for a user device at a given floor as well as in the building generally.

At step 308, a number of users located at the selected first location is determined based on the retrieved records. To achieve this, a set of user devices is first calculated. This set of user devices comprises every user device which is identified by at least one of the retrieved event records. A set of user constructs is then determined, comprising every user construct associated with at least of the user devices. There may be fewer user constructs than user devices, if one user construct is associated with more than one user device. Finally, a count of the unique user constructs is taken, thereby producing the number of users at the location (including all sub-areas within that location).

At step 310, the number of users at the first location can be stored in a data store.

Further analysis can be performed on the hierarchical structure, such as that shown in FIG. 6. Steps 302-306 of FIG. 6 are the same as those of FIG. 5.

At step 312, the dwell time of users located at the selected first location is calculated. To achieve this, for each user (or more precisely, for each user construct) which has a corresponding user device in at least one of the event records, a set of user devices associated with that user is first calculated. The event records are then processed to determine the earliest and the latest event record based on the time information in the event record. The time difference between the earliest event record and the latest event record can then be taken to be the dwell time of the user.

It should be noted that the location of the earliest event record and the location of the latest event record need not be the same, though they should both correspond to nodes in the determined subset. For example, a user may enter a building through a first zone and exit a building through a second zone, while the first location comprises the building as a whole.

Alternatively, a near-real-time dwell time for each user may be calculated, particularly where users are still at the location. In such a case, the dwell time may be calculated as the time difference between the earliest event record and the current time.

At step 314, the dwell time for each user can be stored in a data store.

In use, subsystems can be configured to adapt their service provision based on the number of users present in a location and/or based on the calculated dwell time.

Most notably, the count of the number of users can be used for automatic capacity monitoring. Periodically the number of users at a location can be compared to a predetermined limit for the location. If the number of users exceeds the limit, the subsystem may automatically refuse entry to further people, or may automatically divert users to a different area by means of electronic signage or the like.

A further application is in regards to automated emergency monitoring. For example, if a user has dwelled in a particular location for much longer than the average user does, there may be a risk that the user is injured or has otherwise been rendered immobile. In such a case, when the dwell time exceeds a predetermined value for the location, or has deviated sufficiently far from average, emergency services may be automatically called to determine whether the user requires assistance.

### Infrastructure

The methods above provide for various footfall analytics to be performed. In use, these methods are typically performed in a system. One such exemplary system is shown in FIG. 7.

In this system, the data ultimately originates from a mobile network operator 10. The data is stored in one or more data stores 11. Each of the data stores may be dedicated to a different kind of data. For example, each data store 11 may relate to one or more of real-time network data, network and OSS data, application data or operational data.

The mobile network operator 10 provides an API service 12. In response to receiving an API call, the API service 12 retrieves the appropriate data from the data stores 11, and returns the data. Access to the API service 12 may be limited to only certain parties, and therefore may require authentication. Requests made to the API service 12 may be made as federated queries, such that, in response to the query, multiple data sources are searched and the results compiled. In some cases, the API service 12 may send data to a predetermined recipient other than in response to receiving an API call. For example, this may occur when newly stored data in the data stores 11 matches a predetermined condition. In this manner, the API service 12 may make use of “push” transmission.

The analytics platform 20 is provided to administer the methods noted above.

The analytics platform comprises a client API 21 which is configured to call the appropriate API service 12 at the mobile network operator 10. These calls are performed in order to retrieve the data (such as event records) needed for the analytic methods to be performed. The data can be retrieved in real-time (or at least in near-real-time, where data is available within around 15 minutes of the corresponding event occurring).

Communication between the API service 12 and the client API 21 typically involves a RESTful architecture. Thus, requests for resources may be made by the client API 21 using standard HTTP methods, and responses received using HTML, XML or JSON over FTP or HTTP.

Data received at the client API 21 is then transmitted to a data processing module 22. The received data may fall into one of three categories: structured data (which follows the mandatory core of a pre-agreed standard), semi-structured data (which follows the optional additions to the pre-agreed standard) or unstructured data (which does not follow a pre-agreed standard).

In some cases, a plurality of mobile network operators 10 may provide API services 12 for their respective data. In this case, the client API 21 may retrieve data from each of the mobile network operators 10 in turn, and pass the retrieved data from each mobile network operator 10 in turn to the data processing module 22.

The data processing module 22 is configured to process the incoming data according to its type. More precisely, the data processing module 22 contains one or more operational service components which operate to process the data into a form suitable for storage and/or future use. The components may comprise one or more structured loaders which accept structured data. The components may additionally or alternatively comprise one or more semi-structured loaders which are configured to operate on semi-structured data. The semi-structured loaders may operate to determine the data fields of the semi-structured data and to create appropriate storage objects. The components (which may include the structured loaders or the semi-structured loaders) may operate to perform one or more of data validation, data anonymisation, data enrichment and transformation, data optimisation (such as indexing), data auditing and logging or the like. Once processed, the data is then stored in a data store 23.

The data store 23 typically holds four kinds of data: mobile subscriber data, reference data, system metadata and derived data. Mobile subscriber data contains all the “raw” data originating from the network events and pertaining to a mobile subscriber. This typically includes the event records, and can be regarded as the primary kind of data for analytics. Reference data comprises secondary data which can improve the operation of the analytics. This can include network site/cell configuration data, geographical data (such as GIS polygon data), external footfall verification statistics, population statistics or weather data. Reference data may be updated less frequently than mobile subscriber data, or may be treated as static and not updated. System metadata typically holds data related to the operation of various APIs, such as call definitions and schedule, in order to maintain flexibility within the system. Derived data comprises the calculated and inferred data based on the mobile subscriber data and the reference data.

An analytics processing module 24 is provided, which acts on the data stored in the data store 23. As will be appreciated, the analytics processing module 24 typically implements the footfall analytics methods described herein, then stores the results in the data store 23. More precisely, the analytics processing module 24 may comprise a processor and memory comprising instructions which, when executed by the processor, cause the processor to perform one or more of the methods described above.

The analytics platform 20 further comprises an API service 25 which is configured to receive requests from one or more external entities. The API service 25 may provide for one or more different classes of services. A first class comprises data extraction, whereby there is provided a mechanism for delivering raw data sets. In most cases, this is likely to be derived data. However, in some situations (such as where the primary data source is unavailable), other types of data may also be provided. A second class comprises data visualisation, whereby there is provided a mechanism for delivering data expressed in a visual manner (for example, as charts, graphs) or processed for use in visualisation (such as the provision of KML/KMZ files for geographic annotation and visualisation). A third class comprises insights, whereby there is a mechanism provided for delivering reports (preferably in a pre-defined format). This may function to provide a formatted output of raw data (which may in turn comprise visualisations).

An analytics portal 32 can be provided to allow for a user interface for the analytics platform. In particular, the analytics portal 32 is configured to allow for visualisation and reporting of the data. It typically comprises a webserver which is configured to retrieve data from the analytics platform by means of the API service 25 and to provide one or more dynamic webpages. Each webpage is generated when called to show views of the footfall data. This may be done using standard portlets.

One or more subsystem controllers 34 may also be in communication with the analytics platform by means of the API service 25. The corresponding subsystem (such as an air conditioning subsystem) can be configured to operate according to the retrieved data.

Although shown separately, it is envisioned that the analytics platform and the analytics portal may be operated together, and may be provided as a single system or computer program product, such that the analytics portal simply provides a user interface over the API service 25.

Thus, in a preferred embodiment, a system for performing analytics in a network is provided. The system preferably comprises an analytics platform 20. The analytics platform 20 preferably comprises a client API module 21 configured to call an API service 12 at a mobile network operator 10 and, in response to the call, receive data from the API service 12; a data store 23; a data processing module 22 configured to process the received data and store the processed data in the data store 23; an analytics processing module 24 configured to perform one or more analytics methods (such as those described above in relation to FIGS. 2 to 6); and an API service module 25 configured to configured to receive requests from one or more external entities, and in response to the requests, provide one or more data services.

Example analytics portal 32 will now be described in relation to FIGS. 8A and 8B. In these examples, the analytics portal 32 comprises a webserver 40. The webserver 40 is typically configured to receive requests and responses in common webserver formats (such as HTTP). Responses can include the provision of a dynamic portal or portal pages. The webserver 40 is preferably be configured to adhere to appropriate standards, such as JSR 168. In use, the webserver 40 (or at least components of the webserver 40) may be in communication with various other modules. Thus in the example shown in FIG. 8A, the webserver 40 is in communication with API service 25 in the analytics platform 20. In this manner, content required for operation of the webserver 40 may be supplied via appropriate calls to the API service 25. The webserver 40 is also in communication with a data store 54 via an API service 52 (and preferably via data extraction functions provided by API service 52). In such an example, data store 54 is typically configured to store portal metadata for the webserver 40. The data store 54 and the API service 52 can be separate from the analytics platform 20.

In some embodiments, the API service 52 and the data store 54 are integrated with the API service 25 and the data store 23. An example of this is shown in FIG. 8B, where the webserver 40 is in communication with data store 23 via API service 25 (and preferably via data extraction functions provided by API service 25, as described above). The data store 23 can therefore be configured to store portal metadata, and the API service 25 configured to supply the portal metadata on appropriate calls being made.

As can be seen in both FIGS. 8A and 8B, the webserver 40 comprises a portal access module 42 configured to assess the credentials of a user or a group, and based on this assessment, evaluate whether components (such as portlets) are visible to a given user or group. To this end, the portal access module 42 may be in communication with a data store 23, 54 holding portal metadata, preferably via a suitable API service 25, 52. Based on the results of one or more queries to the API service, the portal access module 42 can then evaluate visibility or access.

The webserver 40 further comprises a layout control module 44. The layout control module 44 is configured to query the API service 25, 52 to retrieve portal metadata, and based on the retrieved portal metadata, determine where and how to display pages and portlets. To this end, the layout control module 44 can be in communication with a portlet library 46 having one or more portlets 48, The portlet library 46 is configured to make available modular components which can be used to display different aspects of data, and preferably adheres to appropriate standards, such as JSR 168. The portlets 48 may include map portlets, chart portlets, image portlets, text portlets, or any other suitable type of portlet.

The portlet library 46 may also be configured to retrieve content from a suitable data store for use in the display of one or more of the portlets 48. In particular, the portlet library 46 may make a call to an API service 25, 52 to retrieve data for use as content. In use, each portlet 48 can be initialised and maintained by the layout control module 44 based on the retrieved portal metadata. In this manner, the layout control module 44 prepares the portal and portal pages for use in responses from the webserver 40.

Thus, in preferred embodiments, a system for operating an analytics portal is provided. The system comprises a portal access control module 42 configured to evaluate the credentials of a user or group, a portlet library 46 configured to store one or more portlets 48, and a layout control module 44 configured to initialise one or more portal pages based on portal metadata and the one or more portlets.

This application describes various embodiments of the present invention by way of one or more examples. However, as will be apparent to the skilled person, various modifications and changes can be made to the embodiments and examples described without departing from the spirit and scope of the present invention. Such modifications and changes are included within the scope of this application.

This application describes various technically implementable analytics systems and methods. Commercial implementation of any of the embodiments described in this application may be subject to applicable privacy laws.

1. A method for inferring a relationship between a first user and an area, the first user associated with one or more first user devices, wherein one or more nodes are capable of serving user devices located within said area, the method comprising:
retrieving a first subset of a plurality of event records, wherein each event record corresponds to an event in a node and comprises user device information, time information, and location information, the first subset comprising one or more event records having user device information corresponding to the one or more first user devices; and
inferring, based on one or more of the user device information, time information and location information associated with the retrieved events, a relationship between the first user and the area.

2. The method of claim 1, further comprising storing the relationship in a data store.

3. The method of claim 1, wherein inferring a relationship comprises:
filtering the first subset to produce a second subset, the second subset comprising event records of the first subset having time information relating to a time between a first time and a second time;
determining an average and a standard deviation for each location having at least one corresponding event record in the second subset; and
inferring the first location for the user based on the average and the standard deviation for each location.

4. The method of claim 3, wherein the first time is a day time and the second time is a night time, and inferring a relationship between the user and the location comprises recording that the location is a work location for the user.

5. The method of claim 3, wherein the first time is a night time and the second time is a day time, and inferring a relationship between the user and the location comprises recording that the location is a home location for the user.

6. The method of claim 1, wherein inferring a relationship comprises for each location corresponding to the location information in at least one record in the first subset:
calculating the number of records having location information relating to the location; and
inferring a relationship between the user and the location based on the number of records.

7. The method of claim 6, wherein inferring a relationship between the user and the first location based on the number comprises:
if the number is greater than a first number, recording that the user is a site worker at the first location;
if the number is less than a first number but greater than a second number, and if a work location for the user is the same as a home location for the user, recording that the user is a home worker at the first location;
if the number is less than a first number but greater than a second number, and if a work location for the user is not the same as a home location for the user, and the first location is associated with the user, recording that the user is an internal visitor at the first location; and
if the number is less than a first number but greater than a second number, and if a work location for the user is not the same as a home location for the user, and the first location is not associated with the user, recording that the user is an external visitor at the first location.

8. The method of claim 1, wherein the event records comprise charging data records generated at the node.

9. The method of claim 1, wherein the operation of a subsystem in a facility is automatically controlled based on the inferred relationship.

10. A computer having computer-executable instructions stored thereon which, when executed by a computer, cause the computer to perform the method of claim 1.

11. A method for determining the presence of users at a location of a plurality of locations organised in a hierarchical structure having a plurality of levels, said plurality of locations being part of an area, each level of the hierarchical structure being associated with an area type of the area, wherein a plurality of nodes are capable of serving user devices located within said area, the method comprising:
receiving an indication of a first location selected from the hierarchical structure;
determining a subset of the plurality of nodes associated with the selected first location, each of said subset of nodes capable of serving user devices located at the first location;
retrieving, from each node in the subset of the plurality of nodes, one or more event records, each event record corresponding to a user device event at the associated node and comprising user device information, event information and location information; and
determining, based on the retrieved records, a number of users located at said selected first location.

12. The method of claim 11, further comprising storing the number of users in a data store.

13. The method of claim 11, further comprising:
comparing the number of users at the first location to a predetermined user capacity for the first location.

14. The method of claim 11, wherein the area type comprises one of a zone, a floor or a building.

15. The method of claim 11, wherein determining a subset of the plurality of nodes associated with the selected first location comprises forming the subset from the node associated with the first location and descendants of the node.

16. A computer-readable medium having computer-executable instructions stored thereon which, when executed by a computer, cause the computer to perform the method of claim 11.
